(19) United States
(12) Patent Application Publication
(10) Pub. No.: US 2023/0358680 A1
(43) Pub. Date: Nov. 9, 2023

(54) IMAGE GENERATION SYSTEM, MICROSCOPE SYSTEM, AND IMAGE GENERATION METHOD

(71) Applicant: SONY GROUP CORPORATION, TOKYO (JP)

(72) Inventors: KENJI IKEDA, TOKYO (JP); HIROKAZU TATSUTA, TOKYO (JP)

(21) Appl. No.: 18/246,015

(22) PCT Filed: Sep. 16, 2021
(86) PCT No.: PCT/JP2021/034199

§ 371 Date: Mar. 20, 2023

(30) Foreign Application Priority Data
Oct. 9, 2020 (JP) 2020-171356

(51) Int. Cl. G01N 21/64; H04N 23/698

(52) U.S. Cl. CPC G01N 21/6458; H04N 23/698

(57) ABSTRACT

A plurality of images are connected such that a subject is represented appropriately in a region where the plurality of images are overlapped with each other. An image generation system includes: an imaging unit (111) that acquires a plurality of partial images by imaging a plurality of regions overlapping with each other; and a connection unit (1331) that connects, on a basis of connection information obtained with at least one channel from among a plurality of channels constituting the plurality of respective partial images as a reference, a plurality of partial images of other channels from among the plurality of channels constituting the plurality of respective partial images to each other.

### FIELD

The present disclosure relates to an image generation system, a microscope system, and an image generation method.

### BACKGROUND

Conventionally, a stitching technique of connecting a plurality of partial images including regions overlapping with each other is known, and is used for panoramic photography, taking microscope images, or the like. In the stitching technique, connection information (offset information of partial images) for connecting portions of the plurality of partial images overlapping with each other is generated by using a method such as template matching. An entire image is obtained by connecting the plurality of partial images by using the connection information generated in this manner.

For example, Patent Literature 1 proposes an information processing apparatus, an information processing method, and a program thereof capable of connecting a plurality of images such that a subject is represented appropriately in a region where the plurality of images are overlapped with each other.

### CITATION LIST

### Patent Literature

Patent Literature 1: JP 2012-10275 A

### SUMMARY

### Technical Problem

However, in a case where the method in Patent Literature 1 is applied to a partial image having a plurality of channels, connection information is generated for each of the channels to perform stitching processing. In this case, in a case where the entire images of the plurality of channels are superimposed on each other, the size of the entire images may be slightly different for each channel due to the influence of the stitching processing, and for example, the entire images may be shifted by several pixels.

In view of the above circumstances, an object of the present disclosure is to provide an image generation system, a microscope system, and an image generation method capable of connecting a plurality of images such that a subject is represented appropriately in a region where the plurality of images are overlapped with each other.

### Solution to Problem

To solve the problems described above, an image generation system according to the present disclosure includes: an imaging unit that acquires a plurality of partial images by imaging a plurality of regions overlapping with each other; and a connection unit that connects, on a basis of connection information obtained with at least one channel from among a plurality of channels constituting the plurality of respective partial images as a reference, a plurality of partial images of other channels from among the plurality of channels constituting the plurality of respective partial images to each other.

### BRIEF DESCRIPTION OF DRAWINGS

FIG. 1 is a block diagram illustrating a configuration example of an information processing system according to a first embodiment.

FIG. 2 is a diagram illustrating specific examples of fluorescence spectra acquired by a fluorescence signal acquisition unit.

FIG. 3 is a diagram describing an outline of a non-negative value matrix factorization.

FIG. 4 is a diagram describing an outline of clustering.

FIG. 5 is a block diagram illustrating a configuration example of a microscope system in a case where the information processing system according to the first embodiment is realized as the microscope system.

FIG. 6 is a schematic diagram of software for processing by an information processing apparatus according to the first embodiment.

FIG. 7 is a flowchart illustrating an outline of processing by the information processing apparatus illustrated in FIG. 1.

FIG. 8 is a diagram schematically illustrating a connection image and a base image that are subjected to stitching processing by the information processing apparatus illustrated in FIG. 1.

FIG. 9 is a diagram schematically illustrating the connection image and the base image after being subjected to stitching processing by the information processing apparatus illustrated in FIG. 1.

FIG. 10 is a schematic diagram for describing calculation of fluorescence separation processing.

FIG. 11 is a diagram for describing matching processing of a comparison block image and the base image by the information processing apparatus illustrated in FIG. 1.

FIG. 12 is a diagram schematically illustrating the comparison block image and the base image after being subjected to the matching processing by the information processing apparatus illustrated in FIG. 1.

FIG. 13 is a flowchart illustrating an outline of boundary detection processing by the information processing apparatus illustrated in FIG. 1.

FIG. 14 is a diagram for describing the boundary detection processing by the information processing apparatus illustrated in FIG. 1.

FIG. 15 is a diagram schematically illustrating the comparison block image and the base image after being subjected to the matching processing by the information processing apparatus illustrated in FIG. 1.

FIG. 16 is a diagram for describing connection processing of the base image and the connection image by the information processing apparatus illustrated in FIG. 1.

FIG. 17 is a flowchart illustrating an outline of processing of a PC according to the first embodiment of the present disclosure.

FIG. 18 is a flowchart illustrating an outline of processing of a PC according to a second embodiment of the present disclosure.

FIG. 19 is a flowchart illustrating an outline of processing of a PC according to a modification of the second embodiment of the present disclosure.

FIG. 20 is a flowchart illustrating an outline of processing of a PC according to a third embodiment of the present disclosure.

FIG. 21 is a diagram illustrating an example of a measurement system of an information processing system according to an embodiment.

FIG. 22 is a diagram for describing a method of calculating the number of fluorescent molecules (or the number of antibodies) in one pixel according to the embodiment.

FIG. 23 is a block diagram illustrating a hardware configuration example of the information processing apparatus according to each embodiment and modification.

### DESCRIPTION OF EMBODIMENTS

Hereinafter, embodiments of the present disclosure will be described in detail with reference to the drawings. Note that, in the following embodiments, the same reference numerals will be given to the same parts and redundant description will be omitted.

Furthermore, the present disclosure will be described according to the order of items described below.

1. First Embodiment

1.1. Configuration example

1.2. Application example to microscope system

1.3. In re least square method

1.4. In re non-negative value matrix factorization (NMF)

1.5. Operation of information processing system

1.6. Description of operation (flowchart)

2. Second Embodiment

2.1. Description of operation (flowchart)

3. Modification of second embodiment

3.1. Description of operation (flowchart)

4. Third Embodiment

4.1. Description of operation (flowchart)

5. Other embodiments

6. Configuration example of measurement system

7. Method of calculating the number of fluorescent molecules (or the number of antibodies)

8. Hardware configuration example

### 1. First Embodiment

First, a first embodiment according to the present disclosure will be described.

### 1.1. Configuration Example

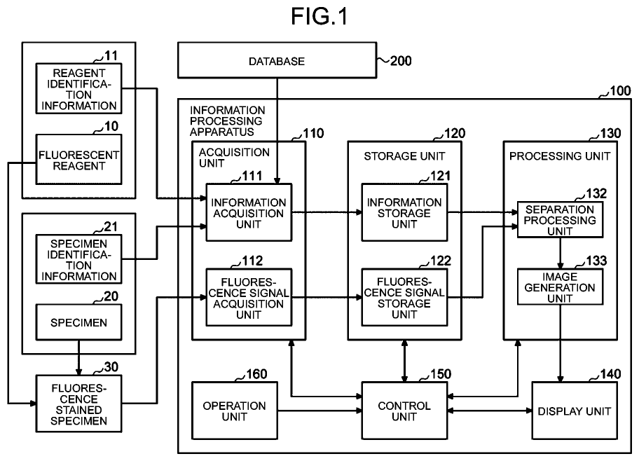

A configuration example of an information processing system (hereinafter, also referred to as an image generation system) according to the present embodiment will be described with reference to FIG. 1. As illustrated in FIG. 1, the information processing system according to the present embodiment includes an information processing apparatus 100 and a database 200, and a fluorescent reagent 10, a specimen 20, and a fluorescence stained specimen 30 exist as inputs to the information processing system.

(Fluorescent Reagent 10)

The fluorescent reagent 10 is a chemical used for staining the specimen 20. The fluorescent reagent 10 is, for example, a fluorescent antibody (including a primary antibody used for direct labeling, or a secondary antibody used for indirect labeling), a fluorescent probe, a nuclear staining reagent, or the like, but the type of the fluorescent reagent 10 is not limited thereto. Furthermore, the fluorescent reagent 10 is managed with identification information (hereinafter, referred to as “reagent identification information 11”) capable of identifying the fluorescent reagent 10 (or a production lot of the fluorescent reagent 10) attached thereto. The reagent identification information 11 is, for example, barcode information or the like (one-dimensional barcode information, two-dimensional barcode information, or the like), but is not limited thereto. The fluorescent reagent 10 varies from production lot to production lot in terms of its property depending on a production method, a state of a cell from which an antibody is acquired, and the like, even in the case of the same product. For example, the fluorescent reagent 10 varies from production lot to production lot in terms of a wavelength spectrum of fluorescence (fluorescence spectrum), a quantum yield, a fluorescent labeling rate, or the like. In view of the above, in the information processing system according to the present embodiment, the fluorescent reagent 10 is managed for each production lot by being attached with the reagent identification information 11. As a result, the information processing apparatus 100 can perform fluorescence separation in consideration of a slight difference in properties that appears for each production lot.

(Specimen 20)

The specimen 20 is prepared from a test body or a tissue sample collected from a human body for the purpose of pathological diagnosis and the like. The specimen 20 may be a tissue section, a cell, or a fine particle, and with respect to the specimen 20, the type of used tissue (for example, an organ or the like), the type of target disease, the attribute (for example, an age, a gender, a blood type, a race, or the like) of a target person, or the lifestyle (for example, eating habits, exercise habits, smoking habits, or the like) of the target person is not particularly limited. Note that, the tissue section can include, for example, a section before staining of a tissue section (hereinafter, also simply referred to as a section) to be stained, a section adjacent to the section stained, a section different from the stained section in the same block (sampled from the same place as that of the stained section), a section in a different block (sampled from a place different from that of the stained section) in the same tissue, a section collected from a different patient, or the like. Furthermore, the specimen 20 is managed with identification information (hereinafter, referred to as “specimen identification information 21”) capable of identifying each specimen 20 attached thereto. The specimen identification information 21 is, similarly to the reagent identification information 11, for example, barcode information or the like (one-dimensional barcode information, two-dimensional barcode information, or the like), but is not limited thereto. The specimen 20 varies in terms of its property depending on the type of used tissue, the type of target disease, the attribute of a target person, the lifestyle of the target person, or the like. For example, the specimen 20 varies in terms of a measurement channel, a wavelength spectrum of autofluorescence (autofluorescence spectrum), or the like depending on the type of used tissue or the like. In view of the above, in the information processing system according to the present embodiment, the specimen 20 is individually managed by being attached with the specimen identification information 21. As a result, the information processing apparatus 100 can perform fluorescence separation in consideration of a slight difference in properties that appears for each specimen 20.

(Fluorescence Stained Specimen 30)

The fluorescence stained specimen 30 is prepared by staining the specimen 20 with the fluorescent reagent 10. In the present embodiment, it is assumed that the fluorescence stained specimen 30 is achieved by staining the specimen 20 with one or more fluorescent reagents 10, but the number of fluorescent reagents 10 used for staining is not particularly limited. Furthermore, a staining method is determined by each combination of the specimen 20 and the fluorescent reagent 10, or the like, and is not particularly limited.

(Information Processing Apparatus 100)

As illustrated in FIG. 1, the information processing apparatus 100 includes an acquisition unit 110, a storage unit 120, a processing unit 130, a display unit 140, a control unit 150, and an operation unit 160. The information processing apparatus 100 can be, for example, a fluorescence microscope or the like, but is not necessarily limited thereto, and may include various apparatuses. For example, the information processing apparatus 100 may be a personal computer (PC) or the like.

(Acquisition Unit 110)

The acquisition unit 110 is configured to acquire information used for various types of processing of the information processing apparatus 100. As illustrated in FIG. 1, the acquisition unit 110 includes an information acquisition unit 111 and a fluorescence signal acquisition unit 112.

(Information Acquisition Unit 111)

The information acquisition unit 111 is configured to acquire information regarding the fluorescent reagent 10 (hereinafter, referred to as “reagent information”) and information regarding the specimen 20 (hereinafter, referred to as, “specimen information”. More specifically, the information acquisition unit 111 acquires the reagent identification information 11 attached to the fluorescent reagent 10 and the specimen identification information 21 attached to the specimen 20, which are used for generating the fluorescence stained specimen 30. For example, the information acquisition unit 111 acquires the reagent identification information 11 and the specimen identification information 21 by using a barcode reader or the like. Then, the information acquisition unit 111 acquires the reagent information and the specimen information on the basis of the reagent identification information 11 and the specimen identification information 21, respectively, from the database 200. The information acquisition unit 111 stores the acquired information in an information storage unit 121 described later.

Here, in the present embodiment, it is assumed that the specimen information includes information regarding an autofluorescence spectrum (hereinafter, also referred to as an autofluorescence reference spectrum) of one or more autofluorescent substances in the specimen 20, and the reagent information includes information regarding a fluorescence spectrum (hereinafter, also referred to as a fluorescence reference spectrum) of a fluorescent substance in the fluorescence stained specimen 30. Note that the autofluorescence reference spectrum and the fluorescence reference spectrum are also each or collectively referred to as a “reference spectrum”.

(Fluorescence Signal Acquisition Unit 112)

The fluorescence signal acquisition unit 112 is configured to acquire a plurality of fluorescence signals corresponding to a plurality of respective beams of excitation light having different wavelengths when the fluorescence stained specimen 30 (specimen prepared by staining the specimen 20 with the fluorescent reagent 10) is irradiated with the plurality of beams of excitation light. More specifically, the fluorescence signal acquisition unit 112 receives light and outputs a detection signal according to an amount of the received light to acquire a data cube including a fluorescence spectrum of the fluorescence stained specimen 30 (hereinafter, referred to as a stained specimen image) on the basis of the detection signal. Here, the content (including an excitation wavelength, an intensity, or the like) of the excitation light is determined on the basis of the reagent information and the like (in other words, information regarding the fluorescent reagent 10 and the like). Note that the fluorescence signal herein is not particularly limited as long as it is a signal derived from fluorescence, and the fluorescence spectrum is merely an example thereof. In the present description, a case where the fluorescence signal is a fluorescence spectrum will be exemplified.

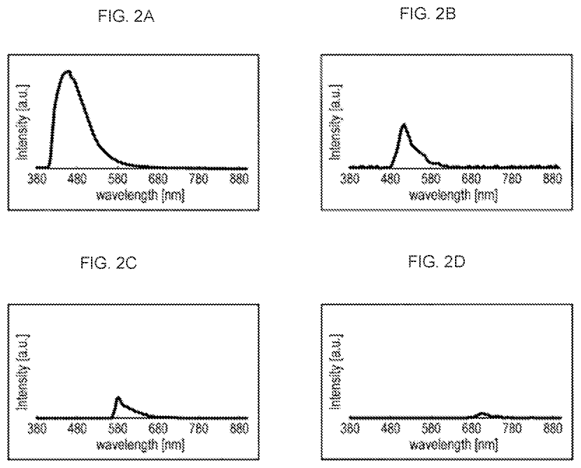

A to D of FIG. 2 are diagrams illustrating specific examples of the fluorescence spectra acquired by the fluorescence signal acquisition unit 112. In A to D of FIG. 2, specific examples of the fluorescence spectra acquired in a case where the fluorescence stained specimen 30 includes four types of fluorescent substances such as DAPI, CK/AF488, PgR/AF594, and ER/AF647 and is irradiated with excitation light having excitation wavelengths of 392 [nm] (A of FIG. 2), 470 [nm] (B of FIG. 2), 549 [nm] (C of FIG. 2), and 628 [nm] (D of FIG. 2), respectively, are illustrated. Note that the fluorescent wavelength is shifted toward a longer wavelength side from the excitation wavelength due to energy released for fluorescence emission (Stake's shift). Furthermore, fluorescent substances included in the fluorescence stained specimen 30 and the excitation wavelength of the irradiated excitation light are not limited to the above. The fluorescence signal acquisition unit 112 stores the stained specimen image including the acquired fluorescence spectrum in a fluorescence signal storage unit 122 described later.

(Storage Unit 120)

The storage unit 120 is configured to store information used for various types of processing of the information processing apparatus 100 or information output by the various types of processing. As illustrated in FIG. 1, the storage unit 120 includes the information storage unit 121 and the fluorescence signal storage unit 122.

(Information Storage Unit 121)

The information storage unit 121 is configured to store the reagent information and the specimen information acquired by the information acquisition unit 111.

(Fluorescence Signal Storage Unit 122)

The fluorescence signal storage unit 122 is configured to store the fluorescence signal of the fluorescence stained specimen 30 acquired by the fluorescence signal acquisition unit 112.

(Processing Unit 130)

The processing unit 130 is configured to perform various types of processing including color separation processing. As illustrated in FIG. 1, the processing unit 130 includes a separation processing unit 132 and an image generation unit 133.

(Separation Processing Unit 132)

The separation processing unit 132 is configured to separate the stained specimen image into fluorescence spectra for each fluorescent substance, and extracts autofluorescence spectra from the input stained specimen image to generate an autofluorescence component corrected image by using the extracted autofluorescence spectra (generation unit). Then, the separation processing unit 132 executes color separation processing of the stained specimen image by using the generated autofluorescence component corrected image (separation unit). The separation processing unit 132 can function as a generation unit, a separation unit, a correction unit, and an image generation unit in the claims.

For example, a least square method (LSM), a weighted least square method (WLSM), or the like may be used for the color separation processing. Furthermore, for example, a non-negative value matrix factorization (NMF), a singular value decomposition (SVD), a principal component analysis (PCA), or the like may be used for extracting the autofluorescence spectrum and/or fluorescence spectrum.

(Operation Unit 160)

The operation unit 160 is configured to receive an operation input from an implementer. More specifically, the operation unit 160 includes various input means such as a keyboard, a mouse, a button, a touch panel, a microphone, or the like, and the implementer operates these input means to perform various inputs to the information processing apparatus 100. Information regarding the operation input performed via the operation unit 160 is provided to the control unit 150.

(Database 200)

The database 200 is an apparatus that manages the reagent information, the specimen information, and the like. More specifically, the database 200 manages the reagent identification information 11 and the specimen identification information 21 in association with the reagent information and the specimen information, respectively. As a result, the information acquisition unit 111 can acquire the reagent information on the basis of the reagent identification information 11 of the fluorescent reagent 10 and the specimen information on the basis of the specimen identification information 21 of the specimen 20, from the database 200.

The reagent information managed by the database 200 is assumed to be information including a measurement channel and a fluorescence reference spectrum specific to the fluorescent substance included in the fluorescent reagent 10 (but not necessarily limited thereto). The “measurement channel” is a concept indicating a fluorescent substance included in the fluorescent reagent 10. The number of fluorescent substances varies depending on the fluorescent reagent 10. Accordingly, the measurement channel is managed in association with each fluorescent reagent 10 as the reagent information. Furthermore, as described above, the fluorescence reference spectrum included in the reagent information is the fluorescence spectrum of each fluorescent substance included in the measurement channel.

Furthermore, the specimen information managed by the database 200 is assumed to be information including a measurement channel and an autofluorescence reference spectrum specific to the autofluorescent substance included in the specimen 20 (but not necessarily limited thereto). The “measurement channel” is a concept indicating an autofluorescent substance included in the specimen 20, and is a concept indicating, for example, Hemoglobin, ArchidonicAcid, Catalase, Collagen, FAD, NADPH, and ProLongDiamond. The number of autofluorescent substances varies depending on the specimen 20. Accordingly, the measurement channel is managed in association with each specimen 20 as the specimen information. Furthermore, as described above, the autofluorescence reference spectrum included in the specimen information is the autofluorescence spectrum of each autofluorescent substance included in the measurement channel. Note that the information managed by the database 200 is not necessarily limited to the above.

The configuration example of the information processing system according to the present embodiment has been described heretofore. Note that the above configuration described with reference to FIG. 1 is merely an example, and the configuration of the information processing system according to the present embodiment is not limited to such an example. For example, the information processing apparatus 100 may not necessarily include all of the configurations illustrated in FIG. 1, or may include a configuration not illustrated in FIG. 1.

Here, the information processing system according to the present embodiment may include an imaging apparatus (including a scanner and the like, for example) that acquires a fluorescence spectrum and an information processing apparatus that performs processing by using the fluorescence spectrum. In this case, the fluorescence signal acquisition unit 112 illustrated in FIG. 1 can be realized by the imaging apparatus, and other configurations can be realized by the information processing apparatus. Furthermore, the information processing system according to the present embodiment may include an imaging apparatus that acquires a fluorescence spectrum and software used for processing using the fluorescence spectrum. In other words, the information processing system may not include the physical configuration (for example, a memory, a processor, or the like) that stores and executes the software. In this case, the fluorescence signal acquisition unit 112 illustrated in FIG. 1 can be realized by the imaging apparatus, and other configurations can be realized by the information processing apparatus on which the software is executed. Then, the software may be provided (for example, from a website, a cloud server, or the like) to the information processing apparatus via a network, or provided to the information processing apparatus via an information processing apparatus via an arbitrary storage medium (for example, a disk or the like). Furthermore, the information processing apparatus on which the software is executed can be various servers (for example, a cloud server and the like), a general-purpose computer, a PC, a tablet PC, or the like. Note that the method by which the software is provided to the information processing apparatus and the type of the information processing apparatus are not limited to the above. Furthermore, the configuration of the information processing system according to the present embodiment is not necessarily limited to the above. It should be noted that a configuration that can be conceived by so-called those skilled in the art can be applied on the basis of a technical level at the time of use.

### 1.2. Application Example to Microscope System

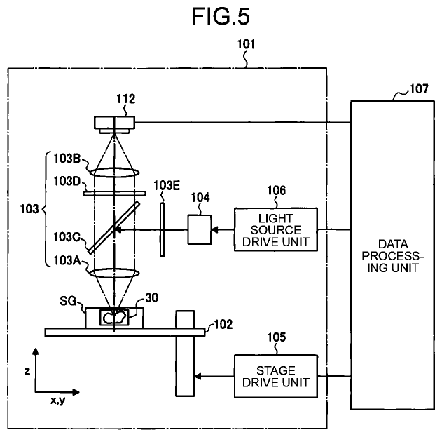

The information processing system described above may be realized as, for example, a microscope system. Thus, next, a configuration example of a microscope system in a case where the information processing system according to the present embodiment is realized as a microscope system will be described with reference to FIG. 5.

As illustrated in FIG. 5, the microscope system according to the present embodiment includes a microscope 101 and a data processing unit 107.

The microscope 101 includes a stage 102, an optical system 103, a light source 104, a stage drive unit 105, a light source drive unit 106, and the fluorescence signal acquisition unit 112.

The stage 102 has a placement surface on which the fluorescence stained specimen 30 can be placed, and is movable in a direction (x-y plane direction) parallel to the placement surface and a direction (z-axis direction) perpendicular to the placement surface by driving the stage drive unit 105. The fluorescence stained specimen 30 has a thickness of, for example, several micrometers to several tens of micrometers in a Z direction, and is sandwiched between a slide glass SG and a cover glass (not illustrated) and is fixed by a predetermined fixing method.

The optical system 103 is arranged above the stage 102. The optical system 103 includes an objective lens 103A, an image forming lens 103B, a dichroic mirror 103C, an emission filter 103D, and an excitation filter 103E. The light source 104 is, for example, a light bulb such as a mercury lamp, a light emitting diode (LED), or the like, and irradiates a fluorescent label attached to the fluorescence stained specimen 30 with excitation light by driving the light source drive unit 106.

The excitation filter 103E generates excitation light by causing only light that has an excitation wavelength for exciting a fluorescent dye in light emitted from the light source 104 to pass therethrough in a case of obtaining a fluorescence image of the fluorescence stained specimen 30. The dichroic mirror 103C reflects the excitation light that has passed through the excitation filter and incident on the dichroic mirror 103C to guide the excitation light to the objective lens 103A. The objective lens 103A focuses the excitation light on the fluorescence stained specimen 30. Then, the objective lens 103A and the image forming lens 103B magnify an image of the fluorescence stained specimen 30 at a predetermined magnification, and form the magnified image on an imaging surface of the fluorescence signal acquisition unit 112.

When the fluorescence stained specimen 30 is irradiated with the excitation light, a stain agent bonded to each tissue of the fluorescence stained specimen 30 emits fluorescence. The fluorescence passes through the dichroic mirror 103C via the objective lens 103A, and reaches the image forming lens 103B via the emission filter 103D. The emission filter 103D absorbs the light magnified by the objective lens 103A described above and has passed through the excitation filter 103E, and allows only a part of colored light to pass therethrough. The image of the colored light from which external light is lost is magnified by the image forming lens 103B and is formed on the fluorescence signal acquisition unit 112, as described above.

The data processing unit 107 is configured to drive the light source 104, acquire a fluorescence image of the fluorescence stained specimen 30 by using the fluorescence signal acquisition unit 112, and perform various types of processing by using the fluorescence image. More specifically, the data processing unit 107 can function as some or all of the configurations of the information acquisition unit 111, the storage unit 120, the processing unit 130, the display unit 140, the control unit 150, and the operation unit 160 of the information processing apparatus 100 or the database 200 described with reference to FIG. 1. For example, the data processing unit 107 functions as the control unit 150 of the information processing apparatus 100 to control driving of the stage drive unit 105 and the light source drive unit 106 or control acquisition of a spectrum by the fluorescence signal acquisition unit 112. Furthermore, the data processing unit 107 functions as the processing unit 130 of the information processing apparatus 100 to generate a fluorescence spectrum, separate the fluorescence spectrum for each fluorescent substance, or generate image information on the basis of the separation result.

The configuration example of the microscope system in the case where the information processing system according to the present embodiment is realized as the microscope system has been described heretofore. Note that the above configuration described with reference to FIG. 5 is merely an example, and the configuration of the microscope system according to the present embodiment is not limited to such an example. For example, the microscope system may not necessarily include all of the configurations illustrated in FIG. 5, or may include a configuration not illustrated in FIG. 5.

### 1.3. In Re Least Square Method

Here, the least square method used in the color separation processing by the separation processing unit 132 will be described. The least square method is to calculate a color mixture rate by fitting a reference spectrum to a fluorescence spectrum, which is a pixel value of each pixel in the input stained specimen image. Note that the color mixture rate is an index indicating a degree to which respective substances are mixed with each other. The following Expression (1) is a reference spectrum (St) from a fluorescence spectrum (Signal). Expression (1) is an expression representing a residual obtained by subtracting the fluorescence reference spectrum and the autofluorescence reference spectrum mixed at a color mixture rate a. Note that “Signal (1×the number of channels)” in Expression (1) indicates that the fluorescence spectra (Signal) exist as many as the number of channels of a wavelength. For example, Signal is a matrix representing one or more fluorescence spectra. Furthermore, “St (the number of substances×the number of channels)” indicates that the reference spectra exist as many as the number of channels of the wavelength for each substance (fluorescent substance and autofluorescent substance). For example, St is a matrix representing one or more reference spectra. Furthermore, “a (1×the number of substances)” indicates that the color mixture rate a is provided for each substance (fluorescent substance and autofluorescent substance). For example, a is a matrix representing the color mixture rate of each of the reference spectra in the fluorescence spectrum.

Signal(1×the number of channels)−a(1×the number of substances)*St(the number of substances×the number of channels) (1)

Then, the separation processing unit 132 calculates the color mixture rate a of each substance at which the sum of squares of a residual Expression (1) becomes minimum. In a case where a result of partial differentiation regarding the color mixture rate a is zero for Expression (1) representing the residual, the sum of squares of the residual becomes minimum. Accordingly, the separation processing unit 132 calculates the color mixture rate a of each substance at which the sum of squares of the residual becomes minimum by solving the following Expression (2). Note that “St′” in Expression (2) indicates a transposed matrix of the reference spectrum St. Furthermore, “inv (St*St′)” indicates an inverse matrix of St*St′.

$$\begin{matrix}\frac{δ ( Signal - {a}^{*} St )}{δ a} = 0 \\ ⇔ 2 {( Signal - {a}^{*} St )}^{*} {St}^{′} = 0 \\ ⇔ ( Signal - {a}^{*} St ) {St}^{′} = 0 \\ ⇔ {Signal}^{*} {St}^{′} - {a}^{*} ( {St}^{*} {St}^{′} ) = 0 \\ ⇔ a = {Signal}^{*} {St}^{′ *} inv ( {St}^{*} {St}^{′} )\end{matrix} \qquad ( 2 )$$

Here, specific examples of each value of the above Expression (1) are expressed by the following Expressions (3) to (5). In the examples of Expressions (3) to (5), a case where the reference spectra (St) of three types of substances (the number of substances is three) are mixed with each other at different color mixture rates a in the fluorescence spectrum (Signal) is expressed.

$$S t = ( \begin{matrix}50 & 100 & 60 & 25 & 4 \\ 10 & 20 & 100 & 20 & 8 \\ 0.1 & 11 & 30 & 100 & 50\end{matrix} ) \qquad ( 3 )$$

a=(3 2 1) (4)

Signal=a*St=(170.1 351 410 215 78) (5)

Then, a specific example of a calculation result of the above Expression (2) by each value of Expressions (3) and (5) is expressed by the following Expression (6). As can be seen from Expression (6), “a=(3 2 1)” (that is, the same value as the above Expression (4)) is correctly calculated as the calculation result.

a=Signal*St′*inv(St*St′)=(3 2 1) (6)

Note that, the separation processing unit 132 may extract the spectra for each fluorescent substance from the fluorescence spectrum by performing calculation regarding the weighted least square method rather than the least square method as described above. In the weighted least square method, a weight is assigned so as to attach importance to an error at a low signal level by using the fact that a noise of the fluorescence spectrum (Signal), which is a measured value, has a Poisson distribution. However, an upper limit value at which weighting is not performed by the weighted least square method is set as an Offset value. The Offset value is determined by characteristics of a sensor used for measurement, and needs to be separately optimized in a case where an imaging element is used as the sensor. In a case where the weighted least square method is performed, the reference spectrum St in the above Expressions (1) and (2) is replaced with St_ represented by the following Expression (7). Note that the following Expression (7) means that St_ is calculated by dividing (in other words, element-dividing) each element (each component) of St represented by a matrix by each corresponding element (each component) in a “Signal+Offset value” also represented by a matrix.

$$St = \frac{St}{Signal + offset value} \qquad ( 7 )$$

Here, a specific example of St_ represented by the above Expression (7) in a case where the Offset value is one and values of the reference spectrum St and the fluorescence spectrum Signal are represented by the above Expressions (3) and (5), respectively, is expressed by the following Expression (8).

$$\begin{matrix}St = \frac{St}{Signal + offset value} \\ = ( \begin{matrix}0.2922 & 0.2841 & 0.146 & 0.1157 & 0.0506 \\ 0.0584 & 0.0568 & 0.2433 & 0.0926 & 0.1013 \\ 5.8445 {e}^{‐ 5} & 0.0313 & 0.073 & 0.4630 & 0.6329\end{matrix} )\end{matrix} \qquad ( 8 )$$

Then, a specific example of a calculation result of the color mixture rate a in this case is expressed by the following Expression (9). As can be seen from Expression (9), “a=(3 2 1)” is correctly calculated as the calculation result.

a=Signal*St_′*inv(St*St_′)=(3 2 1) (9)

### 1.4. In Re Non-Negative Value Matrix Factorization (NMF)

Next, the non-negative value matrix factorization (NMF) used by the separation processing unit 132 to extract an autofluorescence spectrum and/or a fluorescence spectrum will be described. However, the used method is not limited to the non-negative value matrix factorization (NMF), and the singular value decomposition (SVD), the principal component analysis (PCA), or the like may be used.

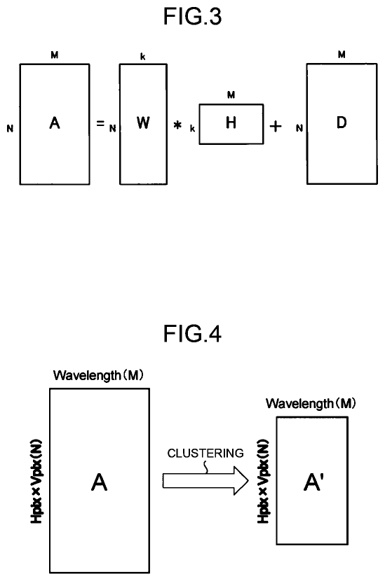

FIG. 3 is a diagram describing an outline of the NMF. As illustrated in FIG. 3, the NMF decomposes a non-negative N-row M-column (N×M) matrix A into a non-negative N-row k-column (N×k) matrix W and a non-negative k-row M-column (k×M) matrix H. The matrix W and the matrix H are determined such that a mean squared residual D between the matrix A and the product (W*H) of the matrix W and the matrix H becomes minimum. In the present embodiment, the matrix A corresponds to a spectrum (N is the number of pixels and M is the number of wavelength channels) before the autofluorescence reference spectrum is extracted, the matrix H corresponds to the extracted autofluorescence reference spectrum (k is the number of autofluorescence reference spectra (in other words, the number of autofluorescent substances) and M is the number of wavelength channels). Here, the mean squared residual D is represented by the following Expression (10). Note that “norm (D, ‘fro’)” refers to a Frobenius norm of the mean squared residual D.

$$D = \frac{norm ( {D}^{′} , {fro}^{′} )}{\sqrt{{N}^{*} M}} \qquad ( 10 )$$

For factorization in the NMF, an iterative method starting with random initial values for the matrix W and the matrix H is used. In the NMF, a value (the number of autofluorescence reference spectra) of k is mandatory, but the initial values of the matrix W and the matrix H can be set as an option rather than being mandatory, and a solution is constant when the initial values of the matrix W and the matrix H are set. On the other hand, in a case where the initial values of the matrix W and the matrix H are not set, these initial values are randomly set and a solution is not constant.

The specimen 20 varies in terms of its property and varies also in terms of an autofluorescence spectrum, depending on the type of used tissue, the type of target disease, the attribute of a target person, the lifestyle of the target person, or the like. Therefore, the information processing apparatus 100 according to a second embodiment can realize more accurate color separation processing by actually measuring the autofluorescence reference spectra for each specimen 20, as described above.

Note that the matrix A, which is an input of the NMF, is a matrix including the same number of rows as the number of pixels N(=Hpix×Vpix) of a stained specimen image and the same number of columns as the number of wavelength channels M, as described above. Therefore, in a case where the number of pixels of the stained specimen image is large or in a case where the number of wavelength channels M is large, the matrix A becomes a very large matrix, so that a calculation cost of the NMF is increased and a processing time becomes long.

In such a case, for example, as illustrated in FIG. 4, by clustering the number of pixels N(=Hpix×Vpix) of the stained image into the designated number of classes N (<Hpix×Vpix), it is possible to suppress redundancy of the processing time due to enlargement of the matrix A.

In the clustering, for example, similar spectra in a wavelength direction and an intensity direction in the stained image are classified into the same class. Therefore, an image having a smaller number of pixels than the number of pixels of the stained image is generated, so that it becomes possible to reduce a scale of a matrix A′ using this image as an input.

(Image Generation Unit 133)

The image generation unit 133 is configured to generate image information on the basis of a separation result of a fluorescence spectrum by the separation processing unit 132. For example, the image generation unit 133 can generate image information by using a fluorescence spectrum corresponding to one or a plurality of fluorescent substances, or generate image information by using an autofluorescence spectrum corresponding to one or a plurality of autofluorescent substances. Note that the number or a combination of fluorescent substances (molecules) or autofluorescent substances (molecules) used by the image generation unit 133 to generate the image information is not particularly limited. Furthermore, in a case where various types of processing (for example, segmentation, calculation of S/N value, or the like) using the fluorescence spectrum or autofluorescence spectrum after separation is performed, the image generation unit 133 may generate image information indicating results of the processing.

(Display Unit 140)

The display unit 140 is configured to display the image information generated by the image generation unit 133 on a display to present the image information to the implementer. Note that the type of display used as the display unit 140 is not particularly limited. Furthermore, although not described in detail in the present embodiment, the image information generated by the image generation unit 133 may be projected by a projector or may be printed by a printer to be presented to the implementer (in other words, the method of outputting the image information is not particularly limited).

(Control Unit 150)

The control unit 150 has a functional configuration of comprehensively controlling general processing performed by the information processing apparatus 100. For example, the control unit 150 controls the start, the end, or the like of the various types of processing as described above (for example, adjustment processing of a placement position of the fluorescence stained specimen 30, irradiation processing of excitation light to the fluorescence stained specimen 30, acquisition processing of a spectrum, generation processing of an autofluorescence component corrected image, color separation processing, generation processing of image information, display processing of the image information, and the like) on the basis of an operation input by the implementer performed via the operation unit 160. Note that the control content of the control unit 150 is not particularly limited. For example, the control unit 150 may control processing (for example, processing regarding an operating system (OS)) generally performed on a general-purpose computer, a PC, a tablet PC, or the like.

### 1.5. Operation of Information Processing System

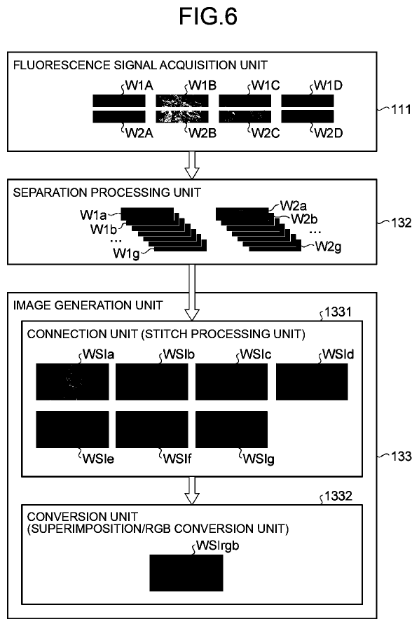

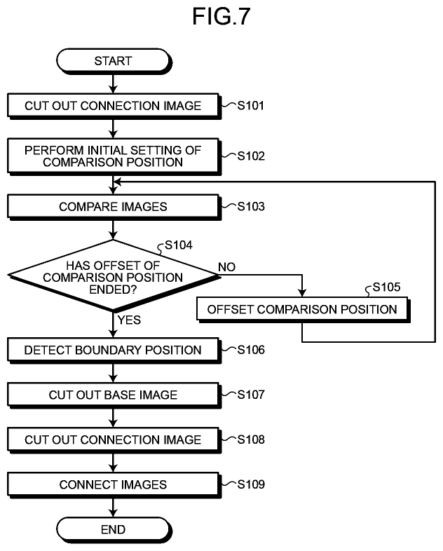

Next, an operation of the above-described information processing system (image generation system) will be described. FIG. 6 is a schematic diagram for describing a part of processing executed by the information processing apparatus according to the present embodiment. FIG. 7 is a flowchart illustrating a schematic operation example executed by the information processing apparatus according to the present embodiment.

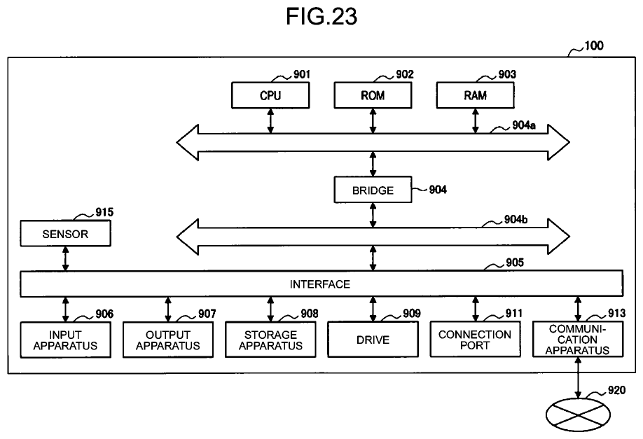

The following processing of the information processing apparatus 100 is realized by cooperation of software stored in a storage apparatus 908, a ROM 902, or the like or software loaded (including download) via a drive 909, a connection port 911, or a communication apparatus 913 and hardware resources constituting the information processing apparatus 100, described later (see FIG. 23). For example, a CPU 901 loads a program constituting software stored in the storage apparatus 908 or the like into a RAM 903 and executes the program. As a result, the following processing is realized.

As illustrated in FIG. 6, the information processing apparatus 100 according to the present embodiment includes the information acquisition unit 111, the separation processing unit 132, a connection unit (stitch processing unit) 1331, and a conversion unit (superimposition/RGB conversion unit) 1332, and executes each processing illustrated in flowcharts exemplified in FIG. 7 and FIGS. 17 to 19 described later.

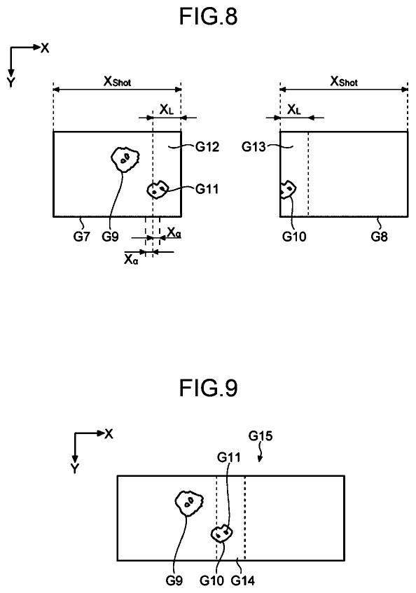

The information acquisition unit 111 images a connection image as a first image and a base image as a second image, which are to be connected by the stitching processing. FIGS. 8 and 9 are diagrams schematically illustrating the connection image and the base image. Note that, in the present embodiment, in order to make the description easy to understand, out of connection in an X-axis direction (horizontal axis) and a Y-axis direction (vertical axis), which are two axis directions perpendicular to each other, the connection in the X-axis direction will be described as an example. The base image and the connection image are examples of partial images in the claims.

A base image G7 and a connection image G8 according to the present embodiment are imaged by, for example, an imaging apparatus capable of taking an image of a subject obtained by an optical microscope (not illustrated). As the subject, a living body cell, which is fluorescently stained, is used. Therefore, as illustrated in FIGS. 8 and 9, the base image G7 and the connection image G8 include a cell fluorescence image G10 and a nucleus fluorescence image G11 in the cell as an image part G9 of the subject.

The base image G7 is imaged, a stage of the optical microscope is moved, and the connection image G8 is imaged. At this time, by controlling the movement of the stage, as illustrated in FIG. 8, both the images G7 and G8 are imaged so as to have allowance regions G12 and G13, which are regions overlapping with each other for stitching processing, respectively.

The base image G7 and the connection image G8 are narrow visual field images, and stitching processing is performed on these images or images obtained by converting these images or the like to obtain a wide visual field image (whole slide image (hereinafter, WSI)).

The base image G7 and the connection image G8 are spectroscopic images (multi-channel images, images having a plurality of wavelength channels) having a lot of information in the wavelength direction. By decomposing (color-separating) the multi-channel images into channels for each fluorescent dye by using a separately prepared spectrum, it is possible to calculate images in which light emission of each fluorescent dye can be confirmed.

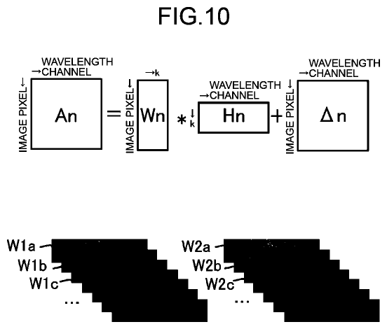

FIG. 10 is a schematic diagram illustrating a state in which the spectroscopic image is color-separated by the separation processing unit 132. An A matrix (image pixel×wavelength channel, a spectroscopic image) to be decomposed is decomposed into a color-separation image W matrix (image pixel×the number of decomposed pieces k) and a spectrum H matrix (the number of decomposed pieces k×wavelength channel) such that a residual A is as small as possible. The color separation method includes the least square method (hereinafter, the LSM) for performing calculation in a state in which k and H are fixed, the non-negative value matrix factorization (hereinafter, the NMF) for performing calculation under a non-negative value condition with an initial k designated, and the like. Note that the images after color separation that emit light with different fluorescent dyes may be superimposed on each other to evaluate the interaction between the cells.

FIG. 10 further illustrates an example of a result of the color-separation image W decomposed from the A matrix. In this example, for each of the narrow visual field images W1 and W2, images with as many variations as the number of decomposed pieces k (=the number of fluorescence channels) is output. For example, for the narrow visual field image W1, as many color-separation images, such as W1a, W1b, W1c, . . . , as the number of decomposed pieces k are output. Similarly, for the narrow visual field image W2, as many color-separation images, such as W2a, W2b, W2c, . . . , as the number of decomposed pieces k are output.

Post-color separation images of the base image G7 and the connection image G8 according to the present embodiment have a plurality of fluorescence channels (for example, channels a, b, c, . . . ). When color separation is performed on base images G7A, 7B, 7C, . . . , and connection images G8A, 8B, 8C, . . . , which are spectroscopic images having a plurality of wavelength channels (for example, channels A, B, C, . . . ), base images G7a, 7b, 7c, . . . , and connection images G8a, 8b, 8c, . . . , which are post-fluorescence separation images having a plurality of fluorescence channels are obtained.

The post-color separation images may be further subjected to distortion correction. The taken narrow visual field images include distortion depending on an optical system used for imaging. The image including the distortion is corrected on the basis of predetermined processing.

Next, a reference fluorescence channel for connecting the base image G7 and the connection image G8 is determined. As the reference fluorescence channel, a fluorescence channel designated by a user may be selected, a fluorescence channel having a high spatial frequency of a luminance signal of an image may be selected, or a fluorescence channel having a high variance value of the luminance signal may be selected, from among combinations of identical fluorescence channel images (for example, the base image G7a and the connection image G8a, the base image G7b and the connection image G8b, the base image Glc and the connection image G8c). Alternatively, a fluorescence channel set in advance in the control unit 150, the processing unit 130, or the like may be selected as the reference fluorescence channel.

For example, in a case where b is selected as the reference fluorescence channel, that is, in a case where the combination of the base image G7b and the connection image G8b is a reference fluorescence image, as described below, connection information is generated on the basis of the image of the reference channel. Note that, in the following description, the “base image G7” and the “connection image G8” indicate the “base image G7 of the selected fluorescence channel (in the above example, the base image G7b)”, and the “connection image G8 of the selected fluorescence channel (in the above example, the connection image G8b)”, respectively, unless otherwise specified.

A region G14 where the base image G7 and the connection image G8 are overlapped with each other is determined by using an allowance regions 12 and 13, and the base image G7 and the connection image G8 are connected with the overlapped region G14 as a reference as illustrated in FIG. 9. Then, a taken image G15 including the image part G9 (the cell fluorescence image G10 and the nucleus fluorescence image G11) of the subject is formed.

Each size of the base image G7 and the connection image G8 is determined by, for example, the magnification of an optical system of the optical microscope, the size of an image sensor included in the imaging apparatus, or the like. That is, a value of a size X_{Shot} of the base image G7 and the connection image G8 illustrated in FIG. 8 in the X-axis direction is mainly determined by a hardware factor. In this case, the respective sizes of the base image G7 and the connection image G8 may be the same. The base image G7 and the connection image G8 of the present embodiment include a plurality of pixels (not illustrated) arranged in the X-axis direction and the Y-axis direction, which are two axis directions perpendicular to each other. Then, each size of the base image G7 and the connection image G8 is, for example, a multiple of 2440 pixels in the X direction and 610 pixels in the Y direction. However, each size of the base image G7 and the connection image G8 is not limited to the above.

A value of a size X_{L} of the allowance regions 12 and 13 of the base image G7 and the connection image G8, respectively, in the X-axis direction is determined within a range in which stitching processing can be performed on the basis of features of both the images 7 and 8. The value of each size X_{L} of the allowance regions 12 and 13 in the X-axis direction can be set to, for example, approximately 5% to 20% of the value of the size X_{Shot} of the base image G7 and the connection image G8 in the X-axis direction.

When the base image G7 and the connection image G8 are imaged, an error may be caused in a relative positional relationship between the base image G7 and the connection image G8 due to a mechanical factor such as a movement error of the stage described above. Therefore, in a case where the base image G7 and the connection image G8 are aligned in the X-axis direction, it is necessary to consider a variation X_{α} based on the above error. In the present embodiment, a value of approximately 5% of the size X_{L} of the allowance regions 12 and 13 is assumed as the variation X_{α}.

Each piece of information of the base image G7 and the connection image G8 imaged by the information acquisition unit 111 is output to the connection unit (stitch processing unit) 1331.

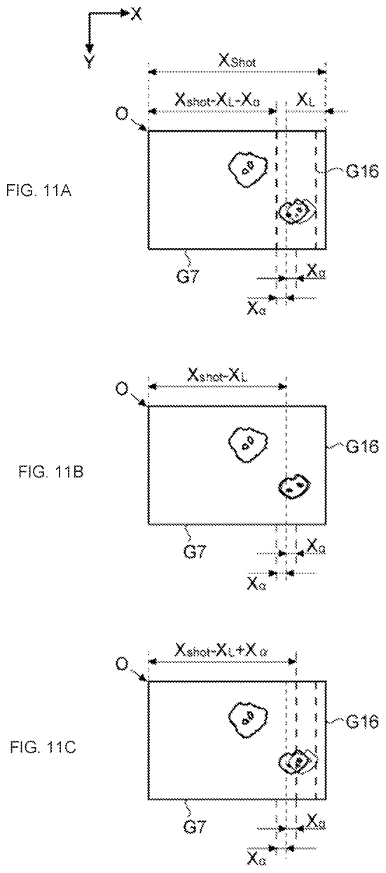

The connection unit (stitch processing unit) 1331 cuts out the image of the allowance region 13 of the connection image G8 as a comparison block image G16 (see FIG. 11) (Step S101 in FIG. 7). As the comparison block image G16, an image of a region of a range larger than or smaller than the allowance region 13 may be cut out.

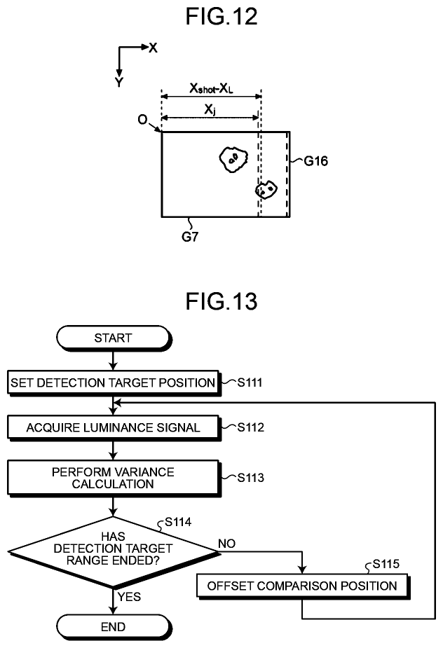

The connection unit (stitch processing unit) 1331 performs matching processing of the comparison block image G16 and the base image G7, and a coordinate at which an optimal matching is obtained is calculated. FIGS. 11 and 12 are diagrams for describing the matching processing.

An initial setting of a comparison position of the comparison block image G16 and the base image G7 is performed (Step S102 in FIG. 7). The position of the initial setting in the present embodiment is, as illustrated in FIG. 11(A), a position, the x coordinate of which is (X_{Shot}−X_{L}−X_{α}). Note that, in the present embodiment, the coordinate is set with an end point O at the upper left of the base image G7 as a reference.

The matching processing of the comparison block image G16 and the base image G7 is performed at the position of the initial setting illustrated in FIG. 11(A) (Step S103). The matching processing is performed by calculating a luminance value for each pixel in a region where the comparison block image G16 and the base image G7 are overlapped with each other and calculating an autocorrelation coefficient on the basis of the luminance value, for example. Alternatively, the matching processing may be performed by calculating a square of a difference of the luminance value for each pixel in the overlapped region. In addition, it is possible to use various algorithms used for image pattern matching.

It is judged whether or not an offset of the comparison position reaches a position, the x coordinate of which is (X_{Shot}−X_{L}+X_{α}) (Step S104). In a case where the offset processing of the comparison position is not completed, the comparison position is offset to the right by the unit of one pixel or the unit of a plurality of pixels for the purpose of speedup of the processing (Step S105). That is, as illustrated in FIGS. 11(A) to 11(C), the comparison block image G16 and the base image G7 are subjected to the matching processing within a range of the x coordinate of (X_{Shot}−X_{L}−X_{α} to X_{Shot}−X_{L}+X_{α}). Therefore, as illustrated in FIG. 12, an offset coordinate Xⱼ, at which the autocorrelation coefficient is highest on the base image G7, is calculated as a position that is appropriate for natural connection of the base image G7 and the connection image G8. The overlapped region G14 of the base image G7 and the connection image G8 illustrated in FIG. 9 corresponds to a region where both the images 7 and 8 are overlapped with each other in a case where the connection image G8 is arranged at the position of the offset coordinate Xⱼ. Therefore, in a case where the offset coordinate Xⱼ coincides with the coordinate (X_{Shot}−X_{L}), the allowance regions 12 and 13 correspond to the overlapped region G14. The information of the offset coordinate Xⱼ is output to the connection unit (stitch processing unit) 1331 as connection position information.

The connection unit (stitch processing unit) 1331 detects connection pixels corresponding to the position on which both the images 7 and 8 are connected in the region G14 where the base image G7 and the connection image G8 are overlapped with each other (Step S106). That is, the connection pixels are pixels located on the boundary of the base image G7 and the connection image G8.

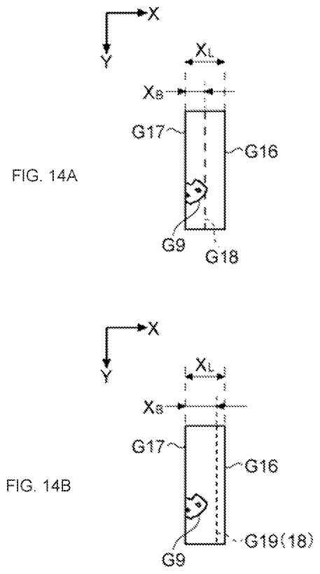

FIG. 13 is a flowchart illustrating an outline of boundary detection processing by the information processing apparatus 100. FIG. 14 is a diagram for describing the boundary detection processing.

A detection target position X_{B} in the comparison block image G16 is set (Step S111). In the present embodiment, as a position of an initial setting of a detection target, a position 17 at the left end of the comparison block image G16 illustrated in FIG. 14 is adopted, and the position is represented as X_{B}=0.

A luminance signal column of a pixel column G18 extending in the Y-axis direction at the position X_{B}=0 of the initial setting of the detection target position is acquired (Step S112). Note that, for the luminance signal column of the pixel column G18, the luminance value of the comparison block image G16 acquired for the matching processing by the connection unit (stitch processing unit) 1331 may be used.

A variance value of the luminance signal column of the pixel column G18 of the detection target position X_{B}=0 is calculated (Step S113). It is judged whether or not the calculation of luminance signal columns has ended within a range of X_{B}=0 to X_{L}, which is a detection target range (Step S114). In a case where it is judged that the calculation of the luminance signal columns does not end within the detection target range (No in Step S114), the detection target position X_{B} is offset to the right by one pixel (Step S115).

That is, as illustrated in FIG. 14(A), in the comparison block image G16, the luminance signal column is acquired for each pixel column G18 extending in the Y-axis direction, and the variance value of the luminance signal column is calculated for each pixel column G18. In a case where it is judged that the calculation of the luminance signal columns has ended within the detection target range (Yes in Step S114), as illustrated in FIG. 14(B), a pixel column G18 having a smallest variance value is selected as connection pixels 19 described above, and the boundary detection processing ends. Therefore, the connection unit (stitch processing unit) 1331 functions as selecting means. The positional information of the selected connection pixels 19 (pixel column G18) is input to the connection unit (stitch processing unit) 1331 again as boundary information together with the connection position information output from the connection unit (stitch processing unit) 1331.

The variance value of the luminance signal column is a value indicating the degree of spreading out of the luminance values of the respective pixels in the pixel column G18 from the average value of the luminance signal column. Therefore, in a case where the image part G9 of the subject is located on the pixel column G18, the variance value becomes large, and in a case where the image part G9 of the subject is not located thereon, the variance value becomes small. Therefore, it can be judged that the image part G9 of the subject is not located on the pixel column G18 having the smallest variance value. That is, the pixel column G18 having the smallest variance value can be judged to be a pixel column other than the image part G9 of the subject.

Alternatively, a predetermined threshold value is determined in advance, and pixel columns G18 having a variance value smaller than the threshold value may be judged to be the pixel columns other than the image part G9 of the subject. Then, from among the pixel columns G18 judged to be the pixel columns other than the image part G9 of the subject, one of the pixel columns G18 may be selected as the connection pixels 19.

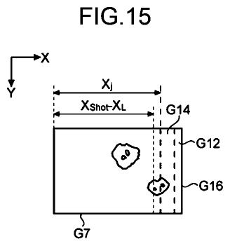

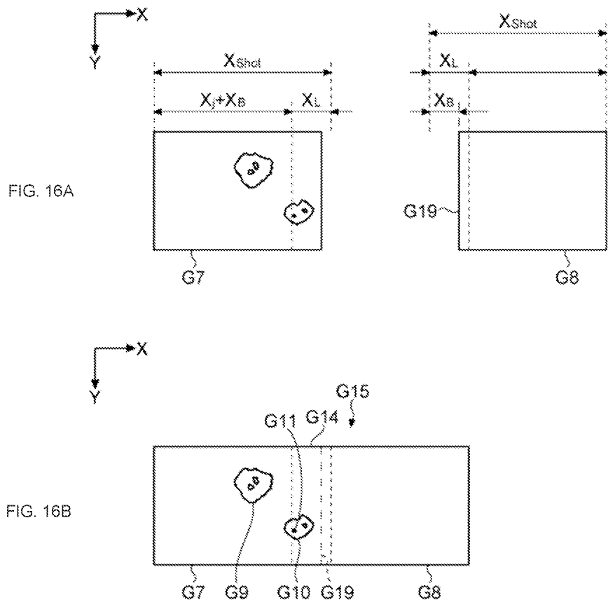

For example, as illustrated in FIG. 15, in some cases, the offset coordinate Xⱼ, at which the base image G7 and the comparison block image G16 are appropriately matched and which is detected by the connection unit (stitch processing unit) 1331, may be larger than (X_{Shot}−X_{L}). In this case, a right end part of the comparison block image G16 is not included in the region G14 where the base image G7 and the connection image G8 are overlapped with each other. Therefore, the connection pixels 19 are selected from the region G14 where both the images 7 and 8 are overlapped with each other except for the right end part of the comparison block image G16. In Step S114 illustrated in FIG. 13, the detection target range may be set in the overlapped region G14 except for the right end part of the comparison block image G16, and in the overlapped region G14, the luminance signal column for each pixel column G18 may be acquired. Alternatively, the luminance signal column may be acquired from the entire comparison block image G16, and the overlapped region G14 may be set as a selectable range when the connection pixels 19 are selected.

The connection unit (stitch processing unit) 1331 synthesizes the base image G7 and the connection image G8 on the basis of the connection position information and the boundary information (hereinafter, simply referred to as connection information). FIG. 16 is a diagram for describing connection processing of the base image G7 and the connection image G8.

As illustrated in FIG. 16(A), the right end part of the base image G7 is cut with the connection pixels 19 as the boundary (Step S107 in FIG. 7). The part to be cut is a right-side part including the pixel column corresponding to the position of a coordinate (Xⱼ+X_{B}). In addition, a left end part of the connection image G8 is cut with the connection pixels 19 as the boundary (Step S108). The part to be cut is a part on the left side of the pixel column corresponding to the position of the coordinate X_{B} with the left end of the connection image G8 as a reference. Alternatively, a part on the right side of the pixel column corresponding to the position of the coordinate (Xⱼ+X_{B}) of the base image G7 may be cut, and a left-side part including the pixel column corresponding to the position of the coordinate X_{B} of the connection image G8 may be cut. That is, as the information of the connection pixels 19, the information of the base image G7 may be used, or the information of the connection image G8 may be used.

As illustrated in FIG. 16(B), the cut base image G7 and connection image G8 are synthesized so as to be coupled, so that one taken image G15 including the image part G9 of the subject is generated (Step S109). As illustrated in FIG. 16(B), the image part G9 of the subject is not located in the connection pixels 19 as the boundary between the base image G7 and the connection image G8. Therefore, it is possible to prevent an inappropriate connection of the image part G9 of the subject on the boundary between the base image G7 and the connection image G8 and a distortion of the shape of the image part G9. As a result, both the images 7 and 8 can be connected such that the subject is represented appropriately in the region G14 where the base image G7 and the connection image G8 are overlapped with each other.

For example, in a case where the cell fluorescence image G10 as the subject is located on the connection pixels 19 as the boundary between the base image G7 and the connection image G8, in some cases, the shape of the fluorescence image G10 may be distorted, and the nucleus fluorescence image G11 included in the cell may be erased, or two fluorescence images G11 may be represented although only one nucleus exists. This may cause a problem in observation in a cell culture experiment, and misdiagnosis may be caused when a cell is diagnosed in the pathological field, for example. In a case where the sizes of the base image G7 and the connection image G8 described above are large, and the sizes of the allowance regions 12 and 13 of both the images 7 and 8 are large, the above problem is likely to arise.

However, in the stitching processing of the base image G7 and the connection image G8 according to the present embodiment, as illustrated in FIG. 16(B), the connection pixels 19 as the boundary between the base image G7 and the connection image G8 are set in the position where the cell fluorescence image G10 is not located. As a result, the cell fluorescence image G10 and the cell nucleus fluorescence image G11 are represented appropriately, and the above problem can be prevented. In addition, it is possible to make the boundary where the base image G7 and the connection image G8 are connected less obvious, so that taken image G15, which is a WSI with high accuracy, can be generated.

In this manner, a WSI (for example, WSIb) of the fluorescence channel (for example, b) selected as a reference can be obtained.

Furthermore, the connection unit (stitch processing unit) 1331 connects the base images G7 (for example, base images G7a, 7c, . . . ), which are post-fluorescence separation images of the fluorescence channels (for example, a, c, . . . ) other than the fluorescence channel (for example, b) selected as the reference, and the connection images G8 (for example, connection images G8a, 8c, . . . ), respectively, and WSI (for example, WSIa, WSIc, . . . ) is generated on the basis of the connection position information and the boundary information. That is, post-fluorescence separation images of the fluorescence channels other than the fluorescence channel selected as the reference are connected on the basis of the connection position information and the boundary information of the post-fluorescence separation image of the fluorescence channel selected as the reference.

The conversion unit (superimposition/RGB conversion unit) 1332 can convert the data of the taken image G15, which is a synthesized image generated by the connection unit (stitch processing unit) 1331, into a format that is easy for a user to handle, and can be presented to the user via the display unit 140 of the information processing apparatus 100.

FIG. 6 is a schematic diagram of software in the first embodiment, illustrating an example of intermediate products and a finally resulting product obtained by the processing. In a first step, narrow visual field images are taken. In FIG. 6, the narrow visual field image W1 and the narrow visual field image W2, which are two spectroscopic images having four types of wavelength channels of 405 nm, 488 nm, 532 nm, and 638 nm, are taken.

As a step subsequent to taking images, there is a color separation step. As the color separation, as described with reference to FIG. 10, the narrow visual field images W1 (for example, W1a, W1b, . . . , and Wig) and the narrow visual field images W2 (W2a, W2b, . . . , and W2g) having a plurality of fluorescence channels (for example, a, b, . . . , and g) are generated on the basis of a plurality of wavelength channel images of the taken spectroscopic image.

Following the color separation, there is a stitching step. As described above, the connection information of the narrow visual field image of the reference fluorescence channel is used for connection of the narrow visual field images of other fluorescence channels, so that there is no shift between the connected WSIs (for example, WSIa, WSIb, . . . , and WSIg).

Following the stitching step, there is a superimposition/RGB conversion step. In order to superimpose two or more WSIs selected or the like by a user on each other and to present the two or more WSIs to be visible to the user, RGB conversion is performed to convert the two or more WSIs into one image WSIrgb, and the one image WSIrgb is displayed on a display or the like.

### 1.6. Description of Operation (Flowchart)

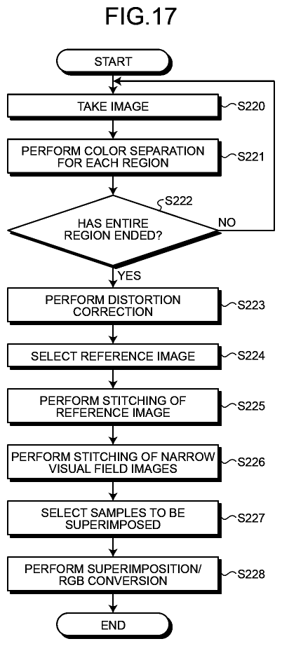

Next, an example of a processing procedure of the entire information processing system according to the present embodiment will be described. FIG. 17 is a flowchart illustrating an example of a processing procedure executed by the information processing system according to the embodiment. Note that the processing procedure illustrated in FIG. 17 is realized by the control unit 150 of the information processing apparatus 100 controlling each unit.

As illustrated in FIG. 17, the control unit 150 images an imaging target by using the information acquisition unit 111, and acquires spectroscopic images of narrow visual field images (Step S220). When the processing in Step S220 ends, the control unit 150 advances the processing to Step S221.

The control unit 150 performs color separation processing for each narrow visual field image imaged in Step S220 (Step S221). When the processing in Step S221 ends, the control unit 150 advances the processing to Step S222.

The control unit 150 judges whether or not the imaging of the narrow visual field images has ended for the entire predetermined region (Step S222). In a case where it is judged to be yes, the control unit 150 advances the processing to Step S223, and in a case where it is judged to be no, performs the processing from Step S220 again.

The control unit 150 performs distortion correction on the color-separated images for each narrow visual field image (Step S223). When the processing in Step S223 ends, the control unit 150 advances the processing to Step S224.

The control unit 150 selects a reference image for defining a shift amount from among the color-separated images for each distortion-corrected narrow visual field image (Step S224). When the processing in Step S224 ends, the control unit 150 advances the processing to Step S225.

The control unit 150 calculates connection information on the basis of the reference image selected in Step S224, and performs stitching processing of the reference image (Step S225). When the processing in Step S225 ends, the control unit 150 advances the processing to Step S226.

The control unit 150 performs stitching processing of the narrow visual field images other than the reference image on the basis of the connection information calculated in Step S225 (Step S226). When the processing in Step S226 ends, the control unit 150 advances the processing to Step S227.

The control unit 150 causes a user to select a plurality of fluorescence channel images to be superimposed from among a plurality of fluorescence channel images after stitching processing (Step S227). When the processing in Step S227 ends, the control unit 150 advances the processing to Step S228.

The control unit 150 superimposes the plurality of fluorescence channel images selected in Step S227, and performs RGB conversion (Step S228). When the processing in Step S228 ends, the control unit 150 ends the program.

### 2. Second Embodiment

In the first embodiment, the reference channel for deriving the connection information is extracted from the fluorescence channels, but the reference channel may be selected from among a plurality of wavelength channels of a spectroscopic image. Note that, as a selecting method, similarly to the first embodiment, a fluorescence channel designated by a user may be selected, a wavelength channel having a high spatial frequency of a luminance signal of an image may be selected, or a channel having a high variance value of the luminance signal may be selected.

The connection information derived from the images of the wavelength channels (for example, the base image G7B and the connection image G8B) selected in this manner may be applied to each of the fluorescence channel images (for example, the base images G1a, 7b, 7c, . . . , and the connection images G8a, 8b, 8c, . . . ) after color separation to execute the stitching processing.

### 2.1. Description of Operation (Flowchart)

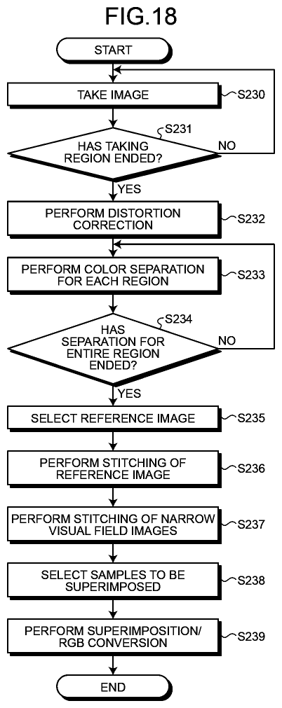

Next, an example of a processing procedure of an entire information processing system according to a second embodiment will be described. FIG. 18 is a flowchart illustrating an example of a processing procedure executed by the information processing system according to the second embodiment. Note that the processing procedure illustrated in FIG. 18 is realized by the control unit 150 of the information processing apparatus 100 controlling each unit.

As illustrated in FIG. 18, the control unit 150 images an imaging target by using the information acquisition unit 111, and acquires spectroscopic images of narrow visual field images (Step S230). When the processing in Step S230 ends, the control unit 150 advances the processing to Step S231.

The control unit 150 judges whether or not the imaging of the narrow visual field images has ended for the entire predetermined region (Step S231). In a case where it is judged to be yes, the control unit 150 advances the processing to Step S232, and in a case where it is judged to be no, performs the processing in Step S230 again.

The control unit 150 performs distortion correction on each of the imaged narrow visual field images (Step S232). When the processing in Step S232 ends, the control unit 150 advances the processing to Steps S233 and S234. However, either the processing from Steps S233 to S234 or the processing from Steps S235 to S36 may be executed first (that is, the order of the processing may be changed), or processing may be executed in parallel.

The control unit 150 performs color separation processing for each narrow visual field image imaged in Step S230 (Step S233). When the processing in Step S233 ends, the control unit 150 advances the processing to Step S234.

The control unit 150 judges whether or not the color separation processing of the narrow visual field images has ended for the entire predetermined region (Step S234). In a case where it is judged to be yes, the control unit 150 advances the processing to Step S235, and in a case where it is judged to be no, performs the processing from Step S233 again.

The control unit 150 selects a reference image for defining a shift amount from among distortion-corrected narrow visual field images (Step S235). When the processing in Step S235 ends, the control unit 150 advances the processing to Step S236.

The control unit 150 calculates connection information on the basis of the reference image selected in Step S235, and performs stitching processing of the reference image (Step S236). When the processing in Step S236 ends, the control unit 150 advances the processing to Step S237.

The control unit 150 performs stitching processing of the narrow visual field images other than the reference image on the basis of the connection information calculated in Step S236 (Step S237). When the processing in Step S237 ends, the control unit 150 advances the processing to Step S238.

The control unit 150 causes the user to select a plurality of WSIs of fluorescence channels to be superimposed from among a plurality of WSIs after stitching processing (Step S238). When the processing in Step S238 ends, the control unit 150 advances the processing to Step S239.

The control unit 150 superimposes the plurality of fluorescence channel images selected in Step S238, and performs RGB conversion (Step S239). When the processing in Step S239 ends, the control unit 150 ends the program.

### 3. Modification of Second Embodiment

In the second embodiment, the connection information derived from the image of the selected wavelength channel may be applied to the images of other wavelength channels other than the selected wavelength channel to execute the stitching processing. In this case, color separation processing is performed on the basis of the images of each connected wavelength channel, so that the WSI of the post-color separation images connected in advance can be obtained.

### 3.1. Description of Operation (Flowchart)

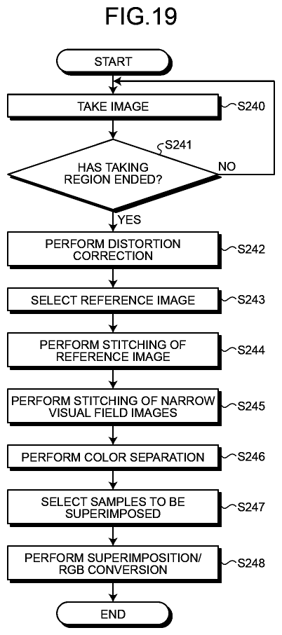

Next, an example of a processing procedure of an entire information processing system according to a modification of the second embodiment will be described. FIG. 19 is a flowchart illustrating an example of a processing procedure executed by the information processing system according to the modification of the second embodiment. Note that the processing procedure illustrated in FIG. 19 is realized by the control unit 150 of the information processing apparatus 100 controlling each unit.

The processing from Steps S240 to S242 is similar to processing from Steps S230 to S232 illustrated in FIG. 18, and thus description thereof is omitted here.

The control unit 150 selects a reference image for defining a shift amount from among distortion-corrected narrow visual field images (Step S243). When the processing in Step S243 ends, the control unit 150 advances the processing to Step S244.

The control unit 150 calculates connection information on the basis of the reference image selected in Step S243, and performs stitching processing of the reference image (Step S244). When the processing in Step S244 ends, the control unit 150 advances the processing to Step S245.

The control unit 150 performs stitching processing of the narrow visual field images other than the reference image on the basis of the connection information calculated in Step S244 (Step S245). When the processing in Step S245 ends, the control unit 150 advances the processing to Step S246.

The control unit 150 performs color separation processing for each WSI connected in Step S245 (Step S246). When the processing in Step S246 ends, the control unit 150 advances the processing to Step S247.

The control unit 150 causes the user to select a plurality of WSIs of the fluorescence channels to be superimposed from among a plurality of connected WSIs (Step S247). When the processing in Step S247 ends, the control unit 150 advances the processing to Step S248.

The control unit 150 superimposes the WSIs of the plurality of fluorescence channels selected in Step S247, and performs RGB conversion (Step S248). When the processing in Step S248 ends, the control unit 150 ends the program.

### 4. Third Embodiment

The step of connecting the narrow visual field images to obtain a wide visual field image may be arranged immediately before finally obtaining an image visible to a user. That is, post-color separation processing may be performed on the narrow visual field images as it is, a plurality of narrow visual field images (for example, the base image G7b and the connection image G8b) corresponding to the fluorescence channel (for example, the fluorescence channel b) designated or the like by the user may be extracted, the plurality of narrow visual field images may be converted into narrow visual field images (for example, a base image G7rgb and a connection image G8rgb) in a format, which is visible by the user, by performing RGB conversion or the like, and then the plurality of narrow visual field images may be connected to obtain the WSI (for example, the WSIrgb).

### 4.1. Description of Operation (Flowchart)

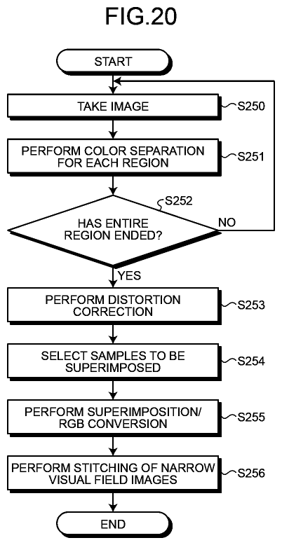

Next, an example of a processing procedure of an entire information processing system according to a third embodiment will be described. FIG. 20 is a flowchart illustrating an example of a processing procedure executed by an information processing system according to a modification of the third embodiment. Note that the processing procedure illustrated in FIG. 20 is realized by the control unit 150 of the information processing apparatus 100 executing a program.

The processing from Steps S250 to S253 is similar to the processing from Steps S220 to S223 illustrated in FIG. 17, and thus description thereof is omitted here.

The control unit 150 causes a user to select a plurality of fluorescence channel images to be superimposed from among a plurality of fluorescence channel images (Step S254). When the processing in Step S254 ends, the control unit 150 advances the processing to Step S255.

The control unit 150 superimposes the plurality of fluorescence channel images selected in Step S254, and performs RGB conversion (Step S255). When the processing in Step S255 ends, the control unit 150 advances the processing to Step S256.

The control unit 150 calculates connection information on the basis of the images RGB-converted in Step S255, and performs stitching processing of the RGB converted images (Step S256). When the processing in Step S256 ends, the control unit 150 ends the program.

In addition to observation, diagnosis, or the like of a cell, the stitching processing by the information treatment apparatus according to each of the above embodiments is applicable in a field of medicine, pathology, or the like to a system or the like that digitizes an image of a cell, a tissue, an organ, or the like of a living body, which is obtained by an optical microscope, to examine the tissue or the like or diagnose a patient by a doctor, a pathologist, or the like on the basis of the digitized image. The stitching processing is applicable not only to the field of medicine or the like but also to other fields. Furthermore, the stitching processing of each of the above-described embodiments is applicable not only to the image obtained by the optical microscope but also to other digital images.

### 5. Other Embodiments

The embodiment according to the present disclosure is not limited to the above-described embodiments, and there are various other embodiments.

In each of the above embodiments, description has been made by using the PC as an example of the information processing apparatus 100. However, a scanner apparatus or the like having a function of an optical microscope may be used as the information processing apparatus 100 according to the present embodiment, and the stitching processing according to each of the above embodiments may be performed by the scanner apparatus or the like.

The algorism described in each of the above embodiments is an example, and an arbitrary algorithm can be adopted as long as the identity of the purpose in each processing unit illustrated in FIG. 6 is maintained.

Note that the spectroscopic image in each of the above embodiments is assumed to be a spectroscopic image having a plurality of wavelength channels, but the spectroscopic image may be represented by other methods.

Furthermore, the stitching processing of the narrow visual field images in each of the above embodiments has been described by using the base image G7 and the connection image G8, but the target of the stitching processing is not limited to these two images, and the stitching processing may be applied to mutual connection of three or more images.

With recent attention to cancer immunotherapy, there is an increasing need to detect markers specifically expressed in many immune cells and cancer cells at a time. As a method of marker detection, there is a detection method using an antibody with a fluorescent dye. As an example of this method, a method of acquiring a fluorescence image by causing a fluorescent dye to emit light and incorporating the light as a signal of a camera can be named. In order to recognize fluorescence at a cell level size (several tens of micrometers) with a generally collected test body size (15 mm×15 mm or the like), it does not fit into the sensor size of the camera. Therefore, it is necessary to acquire a plurality of narrow visual field images, which are stitching targets, and to perform stitching processing on these images to obtain a WSI representing the entire test body. The present disclosure may be applied to such a technical field.

### 6. Configuration Example of Measurement System

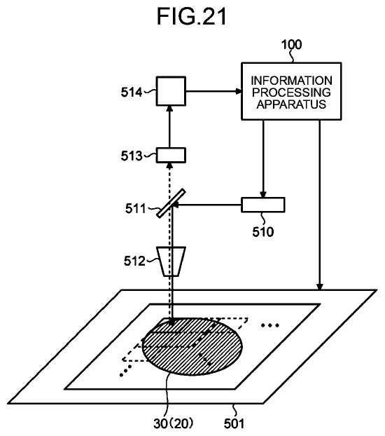

Next, a configuration example of a measurement system in the information processing apparatus 100 according to the above-described embodiments (hereinafter, simply referred to as the embodiment) will be described. FIG. 21 is a diagram illustrating an example of a measurement system of an information processing system according to the embodiment. Note that, in FIG. 21, an example of a measurement system at the time of taking a wide visual field of the fluorescence stained specimen 30 (or the specimen 20, which is a non-stained specimen), such as whole slide imaging (WSI) and the like is illustrated. However, the measurement system according to the embodiment is not limited to the measurement system exemplified in FIG. 21, and may be variously modified as long as it is a measurement system capable of acquiring image data (hereinafter, referred to as wide visual field image data) of a sufficient resolution of the entire taking region or a region of interest, such as a measurement system that takes the entire taking region or a necessary region in the entire taking region (also referred to as a region of interest) at a time, a measurement system that acquires an image of the entire taking region or a region of interest by line scanning, or the like.

As illustrated in FIG. 21, the measurement system according to the embodiment includes, for example, the information processing apparatus 100, an XY stage 501, an excitation light source 510, a beam splitter 511, an objective lens 512, a spectroscope 513, and a photodetector 514.

The XY stage 501 is a stage on which the fluorescence stained specimen 30 (or the specimen 20), which is an analysis target, is placed, and may be, for example, a stage movable on a plane (XY plane) parallel to a placement surface of the fluorescence stained specimen 30 (or the specimen 20).

The excitation light source 510 is a light source for exciting the fluorescence stained specimen 30 (or the specimen 20), and emits a plurality of beams of excitation light having different wavelengths along a predetermined optical axis, for example.

The beam splitter 511 includes, for example, a dichroic mirror or the like, reflects the excitation light from the excitation light source 510, and allows fluorescence from the fluorescence stained specimen 30 (or the specimen 20) to pass therethrough.

The objective lens 512 irradiates the fluorescence stained specimen 30 (or the specimen 20) on the XY stage 501 with the excitation light reflected by the beam splitter 511.

The spectroscope 513 is configured by using one or more prisms, lenses, or the like, and disperses a fluorescence emitted from the fluorescence stained specimen 30 (or the specimen 20) and passed through the objective lens 512 and the beam splitter 511 in a predetermined direction.

The photodetector 514 detects a light intensity for each wavelength of the fluorescence dispersed by the spectroscope 513, and inputs a fluorescence signal (fluorescence spectrum and/or autofluorescence spectrum) obtained by the detection to the fluorescence signal acquisition unit 112 of the information processing apparatus 100.

In the configuration as described above, in a case where the entire taking region exceeds a region (hereinafter, referred to as a visual field) that can be taken at a time, such as the WSI, taking each visual field is sequentially performed by moving the visual field by moving the XY stage 501 for each take. Then, by tiling image data (hereinafter, referred to as visual field image data) obtained by taking each visual field, wide visual field image data of the entire taking region is generated. The generated wide visual field image data is stored in, for example, the fluorescence signal storage unit 122. Note that, the tiling of the visual field image data may be executed by the acquisition unit 110 of the information processing apparatus 100, may be executed by the storage unit 120, or may be executed by the processing unit 130.

Then, the processing unit 130 according to the embodiment acquires a coefficient C, that is, a fluorescence-separation image for each fluorescent molecule (or an autofluorescence-separation image for each autofluorescent molecule) by executing the processing described above on the obtained wide visual field image data.

### 7. Method of Calculating the Number of Fluorescent Molecules (or the Number of Antibodies)

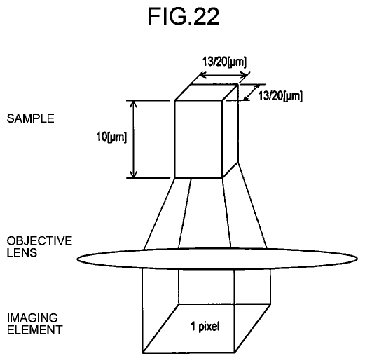

Next, a method of calculating the number of fluorescent molecules (or the number of antibodies) in one pixel in the above-described embodiment will be described. FIG. 22 is a schematic diagram for describing a method of calculating the number of fluorescent molecules (or the number of antibodies) in one pixel in the embodiment. In the example illustrated in FIG. 22, in a case where an imaging element and a sample are arranged with an objective lens interposed therebetween, it is assumed that the size of a bottom surface of the sample corresponding to the imaging element 1 [pixel] is 13/20 (μm)× 13/20 (μm). Then, it is assumed that the thickness of the sample is 10 (μm). In this case, the volume (m³) of the rectangular parallelepiped is represented by 13/20 (μm)× 13/20 (μm)×10 (μm). Note that the volume (liter) is represented by 13/20 (μm)× 13/20 (μm)×10 (μm)×103.

Then, when it is assumed that a concentration of the number of antibodies (which may be the number of fluorescent molecules) included in the sample is uniform and is 300(nM), the number of antibodies per pixel is represented by the following Expression (11).

$$300 * 1 {0}^{- 9} * ( \frac{13}{20} ⋆ \frac{13}{20} * 10 * {( {10}^{- 6} )}^{3} ) * 1 {0}^{3} * 6.02 * 1 {0}^{23} \qquad ( 11 )$$

In this manner, the number of fluorescent molecules or the number of antibodies in the fluorescence stained specimen 30 is calculated as a result of the fluorescence separation processing, so that the implementer can compare the number of fluorescent molecules among a plurality of fluorescent substances or compare data imaged under different conditions. Furthermore, while the luminance (or fluorescent intensity) is a continuous value, the number of fluorescent molecules or the number of antibodies is a discrete value. Therefore, the information processing apparatus 100 according to the modification can reduce a data amount by outputting the image information on the basis of the number of fluorescent molecules or the number of antibodies.

### 8. Hardware Configuration Example

The embodiments of the present disclosure and the modification thereof have been described heretofore. Next, a hardware configuration example of the information processing apparatus 100 according to each embodiment and modification will be described with reference to FIG. 23. FIG. 23 is a block diagram illustrating a hardware configuration example of the information processing apparatus 100. Various types of processing by the information processing apparatus 100 are realized by cooperation of software and hardware described below.

As illustrated in FIG. 23, the information processing apparatus 100 includes the central processing unit (CPU) 901, the read only memory (ROM) 902, the random access memory (RAM) 903, and a host bus 904a. Furthermore, the information processing apparatus 100 includes a bridge 904, an external bus 904b, an interface 905, an input apparatus 906, an output apparatus 907, the storage apparatus 908, the drive 909, the connection port 911, the communication apparatus 913, and a sensor 915. The information processing apparatus 100 may include a processing circuit such as a DSP, an ASIC, or the like, instead of or together with the CPU 901.

The CPU 901 functions as an arithmetic processing apparatus and a control apparatus, and controls general operation in the information processing apparatus 100 according to various programs. Furthermore, the CPU 901 may be a microprocessor. The ROM 902 stores programs, operation parameters, or the like used by the CPU 901. The RAM 903 temporarily stores programs used in execution of the CPU 901, parameters that appropriately change in the execution, or the like. The CPU 901 can embody at least the processing unit 130 and the control unit 150 of the information processing apparatus 100, for example.

The CPU 901, the ROM 902, and the RAM 903 are connected to each other by the host bus 904a including a CPU bus or the like. The host bus 904a is connected to the external bus 904b such as a peripheral component interconnect/interface (PCI) bus or the like via the bridge 904. Note that the host bus 904a, the bridge 904, and the external bus 904b do not necessarily need to be separately configured, and functions of the host bus 904a, the bridge 904, and the external bus 904b may be mounted on a single bus.

The input apparatus 906 is realized by, for example, an apparatus such as a mouse, a keyboard, a touch panel, a button, a microphone, a switch, a lever, or the like, to which information is input by an implementer. Furthermore, the input apparatus 906 may be, for example, a remote control apparatus using infrared rays or other electric waves, or may be an external connection apparatus such as a mobile phone, a PDA, or the like compatible with an operation of the information processing apparatus 100. Moreover, the input apparatus 906 may include, for example, an input control circuit or the like that generates an input signal on the basis of the information input by the implementer by using the input means described above and outputs the generated input signal to the CPU 901. The implementer can input various data to the information processing apparatus 100 or instruct the information processing apparatus 100 to perform a processing operation by operating the input apparatus 906. The input apparatus 906 can embody at least the operation unit 160 of the information processing apparatus 100, for example.

The output apparatus 907 is formed of an apparatus that can visually or auditorily notify the implementer of the acquired information. Such an apparatus includes a display apparatus such as a CRT display apparatus, a liquid crystal display apparatus, a plasma display apparatus, an EL display apparatus, a lamp, or the like, a sound output apparatus such as a speaker, a headphone, or the like, a printer apparatus, or the like. The output apparatus 907 can embody at least the display unit 140 of the information processing apparatus 100, for example.

The storage apparatus 908 is an apparatus for storing data. The storage apparatus 908 is realized by, for example, a magnetic storage unit device such as an HDD, a semiconductor storage device, an optical storage device, a magneto-optical storage device, or the like. The storage apparatus 908 may include a storage medium, a recording apparatus that records data in the storage medium, a reading apparatus that reads out data from the storage medium, a deleting apparatus that deletes data recorded in the storage medium, and the like. The storage apparatus 908 stores programs executed by the CPU 901 or various data, various data acquired from the outside, and the like. The storage apparatus 908 can embody at least the storage unit 120 of the information processing apparatus 100, for example.

The drive 909 is a reader/writer for the storage medium, and is built into or externally mounted on the information processing apparatus 100. The drive 909 reads out information recorded in an attached removable storage medium such as a magnetic disk, an optical disk, a magneto-optical disk, a semiconductor memory, or the like, and outputs the information to the RAM 903. Furthermore, the drive 909 can write information to the removable storage medium.

The connection port 911 is an interface connected to an external device, and is a connection port to an external device capable of transmitting data by, for example, a universal serial bus (USB) or the like.

The communication apparatus 913 is, for example, a communication interface formed of a communication device or the like for connecting to a network 920. The communication apparatus 913 is, for example, a communication card or the like for a wired or wireless local area network (LAN), long term evolution (LTE), Bluetooth (registered trademark), or a wireless USB (WUSB). Furthermore, the communication apparatus 913 may be a router for optical communication, a router for an asymmetric digital subscriber line (ADSL), a modem for various kinds of communication, or the like. The communication apparatus 913 is capable of transmitting and receiving signals and the like, for example, to or from the Internet or other communication devices in compliance with a predetermined protocol such as, for example, TCP/IP and the like.

The sensor 915 includes a sensor (for example, an imaging element or the like) capable of acquiring a spectrum in the present embodiment, and may include other sensors (for example, an acceleration sensor, a gyro sensor, a geomagnetic sensor, a pressure sensor, a sound sensor, a distance measuring sensor, or the like). The sensor 915 can embody at least the fluorescence signal acquisition unit 112 of the information processing apparatus 100, for example.

Note that the network 920 is a wired or wireless transmission path of information transmitted from an apparatus connected to the network 920. For example, the network 920 may include a public network such as the Internet, a telephone network, a satellite communication network, or the like, various local area networks (LANs) including Ethernet (registered trademark), a wide area network (WAN), or the like. Furthermore, the network 920 may include a dedicated line network such as the Internet protocol-virtual private network (IP-VPN) or the like.

The hardware configuration example capable of realizing the functions of the information processing apparatus 100 has been described heretofore. Each constituent element described above may be realized by using a general-purpose member or may be realized by hardware specialized for the function of each constituent element. Therefore, it is possible to appropriately change the hardware configuration to be used according to a technical level at the time of carrying out the present disclosure.

Note that a computer program for realizing each function of the information processing apparatus 100 as described above can be prepared and mounted in a PC or the like. Furthermore, a computer readable recording medium in which such a computer program is stored can be provided. The recording medium includes, for example, a magnetic disk, an optical disk, a magneto-optical disk, a flash memory, and the like. Furthermore, the computer program described above may be distributed through, for example, a network without using the recording medium.

The preferred embodiments of the present disclosure have been described in detail heretofore with reference to the accompanying drawings, but a technical scope of the present disclosure is not limited to such examples. It will be apparent to those skilled in the art of the present disclosure that various modifications or alterations can be conceived within the scope of the technical idea described in the claims, and it is naturally understood that these modifications or alterations also fall within the technical scope of the present disclosure.

The above-described configuration illustrates an example of the present embodiment, and naturally falls within the technical scope of the present disclosure.

Furthermore, the advantageous effects described in the present specification are merely illustrative or exemplary rather than restrictive. That is, the technology according to the present disclosure can accomplish other advantageous effects apparent to those skilled in the art from the description of the present specification, in addition to or instead of the advantageous effects described above.

Note that the following configurations also fall within the technical scope of the present disclosure.

(1)

An image generation system including:
an imaging unit that acquires a plurality of partial images by imaging a plurality of regions overlapping with each other; and
a connection unit that connects, on a basis of connection information obtained with at least one channel from among a plurality of channels constituting the plurality of respective partial images as a reference, a plurality of partial images of other channels from among the plurality of channels constituting the plurality of respective partial images to each other.
   (2)

The image generation system according to (1), wherein
the imaging unit acquires the plurality of partial images for each of a plurality of wavelengths.
   (3)

The image generation system according to (2), including
a separation processing unit that performs fluorescence separation processing on a basis of the plurality of partial images and a reference vector to generate a plurality of post-fluorescence separation images.
   (4)

The image generation system according to any one of (1) to (3), wherein
the plurality of partial images have a same size.
   (5)

The image generation system according to (3) or (4), wherein
the at least one channel is a specific fluorescence channel from among a plurality of fluorescence channels after the fluorescence separation processing, and the other channels are fluorescence channels other than the specific fluorescence channel.
   (6)

The image generation system according to (3) or (4), wherein
the at least one channel is a specific wavelength channel from among the plurality of wavelength channels, and the other channels are a plurality of fluorescence channels after the fluorescence separation processing.
   (7)

The image generation system according to (3) or (4), wherein
the at least one channel is a specific wavelength channel from among the plurality of wavelength channels, and the other channels are wavelength channels other than the specific wavelength channel.
   (8)

The image generation system according to any one of (5) to (7), wherein
the separation processing unit performs the fluorescence separation processing on a basis of the plurality of partial images of the plurality of wavelength channels for each of the regions obtained by the imaging unit imaging each of the plurality of regions and the reference vector to generate the plurality of post-fluorescence separation images for each of the regions.
   (9)

The image generation system according to (6) or (7), wherein
the separation processing unit performs the fluorescence separation processing on a basis of a connection image in which the plurality of partial images of the plurality of wavelength channels are connected to each other on a basis of overlap between the regions and the reference vector to generate the plurality of post-fluorescence separation images of the connection image.
   (10)

The image generation system according to any one of (1) to (9), wherein
the at least one channel is a channel designated from the plurality of channels by a user.
   (11)

The image generation system according to any one of (1) to (9), wherein
the at least one channel is determined on a basis of a spatial frequency or a variance value of a luminance signal of an image of the plurality of channels.
   (12)

The image generation system according to any one of (1) to (9), wherein
the at least one channel is a channel set in advance.
   (13)

The image generation system according to any one of (1) to (9), including:
a designation unit that causes a user to designate the at least one channel from the plurality of channels before connection by the connection unit; and a generation unit that generates an image in which the plurality of partial images of a channel designated by the user are connected to each other on a basis of connection information obtained with the channel designated by the user as a reference and a conversion unit that converts for presenting the generated image to be visible to the user.
   (14)

The image generation system according to any one of (1) to (13), wherein
the connection unit generates the connection information on a basis of a variance value of a luminance signal for each pixel column of each of two partial images overlapping with each other.
   (15)

An image generation system including:
an imaging unit that images a plurality of partial images for each of a plurality of wavelengths by imaging a plurality of regions overlapping with each other;
a separation processing unit that performs fluorescence separation processing on a basis of the plurality of partial images for each of the plurality of wavelengths and a reference vector to generate a plurality of fluorescence-separated partial images; and
a connection unit that connects, on a basis of connection information obtained with a plurality of partially superimposed images obtained by superimposing at least a part of the plurality of fluorescence-separated partial images as a reference, the plurality of partially superimposed images to each other, to acquire an imaged image including an image part of a subject.
   (16)

A microscope system, including:
an imaging unit that acquires a plurality of partial images by imaging regions overlapping with each other; and
a connection unit that connects, on a basis of connection information obtained with at least one channel from among a plurality of channels constituting the plurality of respective partial images as a reference, a plurality of partial images of other channels from among the plurality of channels constituting the plurality of respective partial images to each other.
   (17)

An image generation method including:
an imaging step of acquiring a plurality of partial images by imaging regions overlapping with each other; and
a connection step of connecting, on a basis of connection information obtained with at least one channel from among a plurality of channels constituting the plurality of respective partial images as a reference, a plurality of partial images of other channels from among the plurality of channels constituting the plurality of respective partial images to each other.

### REFERENCE SIGNS LIST

10 FLUORESCENT REAGENT
11 REAGENT IDENTIFICATION INFORMATION
20 SPECIMEN
21 SPECIMEN IDENTIFICATION INFORMATION
30 FLUORESCENCE STAINED SPECIMEN
100 INFORMATION PROCESSING APPARATUS
110 ACQUISITION UNIT
111 INFORMATION ACQUISITION UNIT
112 FLUORESCENCE SIGNAL ACQUISITION UNIT
120 STORAGE UNIT
121 INFORMATION STORAGE UNIT
122 FLUORESCENCE SIGNAL STORAGE UNIT
130 PROCESSING UNIT
132 SEPARATION PROCESSING UNIT
133 IMAGE GENERATION UNIT
140 DISPLAY UNIT
150 CONTROL UNIT
160 OPERATION UNIT
200 DATABASE
1331 CONNECTION UNIT (STITCH PROCESSING UNIT)
1332 CONVERSION UNIT (SUPERIMPOSITION/RGB CONVERSION UNIT)
G7 BASE IMAGE
G8 CONNECTION IMAGE
G9 IMAGE PART OF SUBJECT
G10 CELL FLUORESCENCE IMAGE
G11 NUCLEUS FLUORESCENCE IMAGE
G14 OVERLAPPED REGION
G15 TAKEN IMAGE
G16 COMPARISON BLOCK IMAGE
G18 PIXEL COLUMN
G19 CONNECTION PIXEL

1. An image generation system including:
an imaging unit that acquires a plurality of partial images by imaging a plurality of regions overlapping with each other; and
a connection unit that connects, on a basis of connection information obtained with at least one channel from among a plurality of channels constituting the plurality of respective partial images as a reference, a plurality of partial images of other channels from among the plurality of channels constituting the plurality of respective partial images to each other.

2. The image generation system according to claim 1, wherein
the imaging unit acquires the plurality of partial images for each of a plurality of wavelengths.

3. The image generation system according to claim 2, including
a separation processing unit that performs fluorescence separation processing on a basis of the plurality of partial images and a reference vector to generate a plurality of post-fluorescence separation images.

4. The image generation system according to claim 1, wherein
the plurality of partial images have a same size.

5. The image generation system according to claim 3, wherein
the at least one channel is a specific fluorescence channel from among a plurality of fluorescence channels after the fluorescence separation processing, and the other channels are fluorescence channels other than the specific fluorescence channel.

6. The image generation system according to claim 3, wherein
the at least one channel is a specific wavelength channel from among the plurality of wavelength channels, and the other channels are a plurality of fluorescence channels after the fluorescence separation processing.

7. The image generation system according to claim 3, wherein
the at least one channel is a specific wavelength channel from among the plurality of wavelength channels, and the other channels are wavelength channels other than the specific wavelength channel.

8. The image generation system according to claim 5, wherein
the separation processing unit performs the fluorescence separation processing on a basis of the plurality of partial images of the plurality of wavelength channels for each of the regions obtained by the imaging unit imaging each of the plurality of regions and the reference vector to generate the plurality of post-fluorescence separation images for each of the regions.

9. The image generation system according to claim 6, wherein
the separation processing unit performs the fluorescence separation processing on a basis of a connection image in which the plurality of partial images of the plurality of wavelength channels are connected to each other on a basis of overlap between the regions and the reference vector to generate the plurality of post-fluorescence separation images of the connection image.

10. The image generation system according to claim 1, wherein
the at least one channel is a channel designated from the plurality of channels by a user.

11. The image generation system according to claim 1, wherein
the at least one channel is determined on a basis of a spatial frequency or a variance value of a luminance signal of an image of the plurality of channels.

12. The image generation system according to claim 1, wherein
the at least one channel is a channel set in advance.

13. The image generation system according to claim 1, including:
a designation unit that causes a user to designate the at least one channel from the plurality of channels before connection by the connection unit; and
a generation unit that generates an image in which the plurality of partial images of a channel designated by the user are connected to each other on a basis of connection information obtained with the channel designated by the user as a reference and a conversion unit that converts for presenting the generated image to be visible to the user.

14. The image generation system according to claim 1, wherein
the connection unit generates the connection information on a basis of a variance value of a luminance signal for each pixel column of each of two partial images overlapping with each other.

15. An image generation system including:
an imaging unit that images a plurality of partial images for each of a plurality of wavelengths by imaging a plurality of regions overlapping with each other;
a separation processing unit that performs fluorescence separation processing on a basis of the plurality of partial images for each of the plurality of wavelengths and a reference vector to generate a plurality of fluorescence-separated partial images; and
a connection unit that connects, on a basis of connection information obtained with a plurality of partially superimposed images obtained by superimposing at least a part of the plurality of fluorescence-separated partial images as a reference, the plurality of partially superimposed images to each other, to acquire an imaged image including an image part of a subject.

16. A microscope system, including:
an imaging unit that acquires a plurality of partial images by imaging regions overlapping with each other; and
a connection unit that connects, on a basis of connection information obtained with at least one channel from among a plurality of channels constituting the plurality of respective partial images as a reference, a plurality of partial images of other channels from among the plurality of channels constituting the plurality of respective partial images to each other.

17. An image generation method including:
an imaging step of acquiring a plurality of partial images by imaging regions overlapping with each other; and
a connection step of connecting, on a basis of connection information obtained with at least one channel from among a plurality of channels constituting the plurality of respective partial images as a reference, a plurality of partial images of other channels from among the plurality of channels constituting the plurality of respective partial images to each other.
